(19) United States
(12) Patent Application Publication
(10) Pub. No.: US 2006/0218514 A1
(43) Pub. Date: Sep. 28, 2006

(54) Power supply analysis method and program product for executing the same

(75) Inventor: Hiroyuki Uchida, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/367,356

(22) Filed: Mar. 6, 2006

(30) Foreign Application Priority Data
Mar. 8, 2005 (JP) 2005-063725

(51) Int. Cl. G06F 17/50

(52) U.S. Cl. 716/5

(57) ABSTRACT

A method of power supply analysis includes the steps of dividing a package substrate to which a semiconductor device is mounted into a plurality of first area, specifying virtual flat plate conductors to correspond to the plurality of the first areas, calculating a plurality of electrical properties including inductance characteristics of the flat plate conductors, and correcting the inductance characteristics based on the number of via holes in each of the first areas.

### BACKGROUND OF THE INVENTION

1. Field of the Invention

The present invention relates to a method of power supply analysis of a semiconductor integrated circuit and particularly to a power supply analysis method and a power supply analysis program at a design stage.

2. Description of Related Art

In a case in which numerous logic cells switch simultaneously or I/O cells for input and output with external device switch simultaneously, a large current flows instantaneously, thereby producing power supply noise due to inductance components on a power wiring. This power supply noise causes a malfunction of a circuit inside a semiconductor apparatus.

Designing a circuit without properly analyzing an effect of power supply as described above could result in a larger power supply noise in a manufactured circuit. Having an excessively large power supply noise could lead to redesigning. Therefore it is necessary to perform an appropriate power supply analysis at a design stage and then to design a circuit arranged for power supply wiring.

Even though a method is developed to analyze power supply inside a semiconductor integrated circuit, an influence of a package substrate cannot be considered. For example when expressing a power supply on a package substrate as an ideal power supply without modeling, a power supply of a semiconductor integrated circuit cannot be accurately analyzed.

In a conventional art, a package substrate has not been modeled to be analyzed, thus it has been impossible to perform a power supply analysis factoring in a package substrate before package design.

### SUMMARY OF THE INVENTION

According to an aspect of the present invention, there is provided a power supply analysis method that divides a package substrate to which a semiconductor device is mounted into a plurality of first areas, specifies virtual flat plate conductors, calculates a plurality of electric properties including inductance characteristics of the flat plate conductors, and corrects the inductance characteristics based on the number of via holes in each of the first areas.

According to another aspect of the present invention, there is provided a program product to execute power supply analysis of a semiconductor apparatus that causes a computer to execute; division of a package substrate to which a semiconductor device is mounted into a plurality of first areas; specification of virtual flat plate conductors to the plurality of first areas; calculation of a plurality of electrical properties including inductance characteristics of the flat plate conductors; correction of the inductance characteristics based on the number of via holes in each of the first areas.

By performing the power supply analysis described above, it is possible to achieve a power supply analysis of a package substrate before designing a package substrate of a semiconductor integrated circuit.

### BRIEF DESCRIPTION OF THE DRAWINGS

The above and other objects, advantages and features of the present invention will be more apparent from the following description taken in conjunction with the accompanying drawings, in which:

FIG. 1A is a package substrate in which this embodiment is adapted to;

FIG. 1B is a package substrate in which this embodiment is adapted to;

FIG. 2 is a block diagram showing hardware of a power supply analysis apparatus;

FIG. 3 is a block diagram showing a power supply analysis apparatus;

FIG. 4 is a flow chart showing a flow of this embodiment;

FIG. 5A is a view showing an estimated flat plate conductor and its mesh partition;

FIG. 5B is a view showing a structure of a wiring model in which this embodiment is adapted to; and

FIG. 6 is a view explaining a correction based on via holes.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

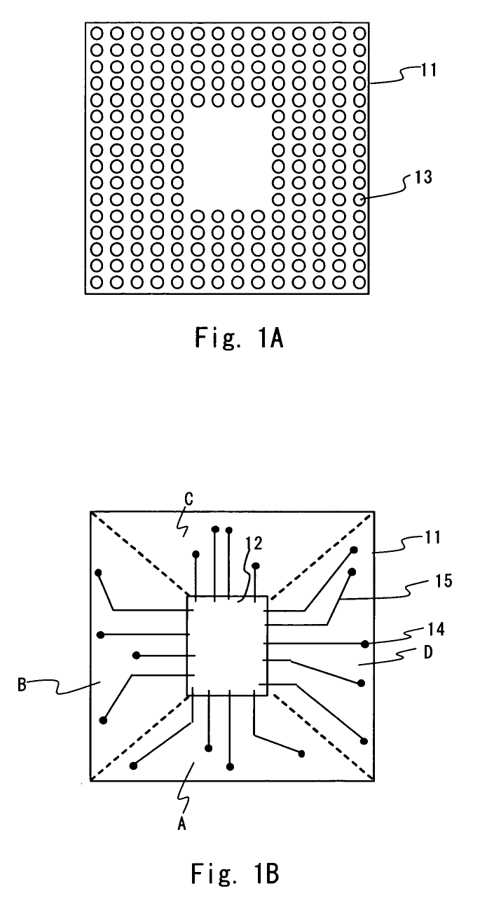

An embodiment of the present invention is described hereinafter with reference to the drawings. FIGS. 1A and 1B are schematic views showing an example of a semiconductor apparatus for which a power supply analysis of this invention is intended. FIG. 1A is a plan view where the semiconductor device 100 is connected to a printed circuit board and so forth as viewed from the board. FIG. 1B is a plan view as viewed from a surface to which semiconductor device are mounted.

The semiconductor apparatus 100 illustrated in FIGS. 1A and 1B includes a package substrate 11 such as BGA and a semiconductor device 12. The package substrate 11 includes bump electrodes 13, via holes 14, and signal lines 15 and the like. A pad of the semiconductor device 12 is connected to the signal lines 15 and inputs and outputs a signal through the via holes 14 and bump electrodes 13. Furthermore the semiconductor device 12 is supplied with power supply voltage and ground voltage through the bump electrodes 13, via holes 14 and signal lines 15.

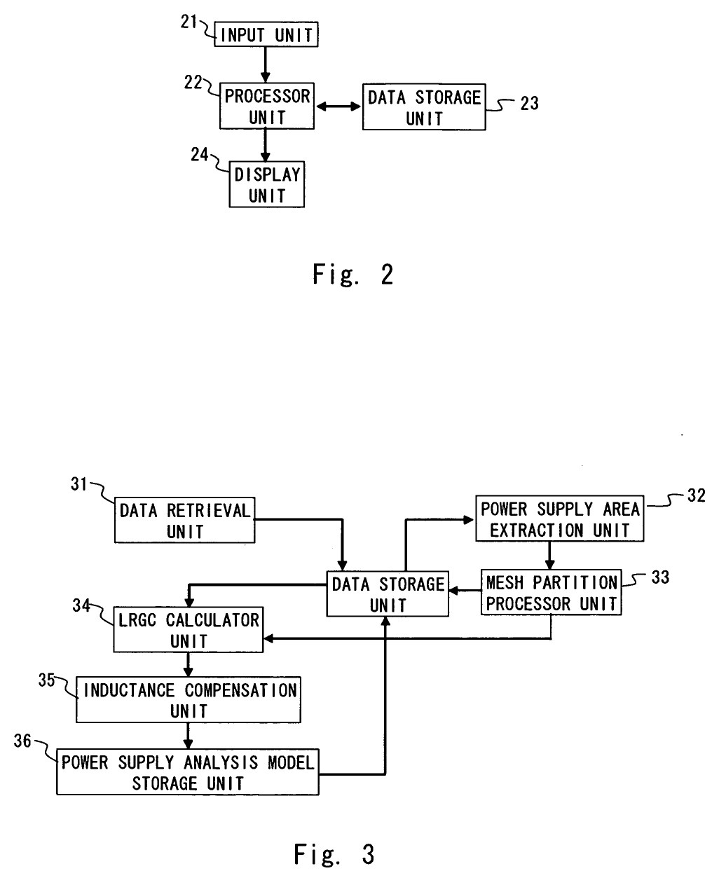

A power supply analysis model generation apparatus 200 is described hereinafter. FIG. 2 is a block diagram showing a configuration example of hardware for the power supply analysis model generation apparatus according to this embodiment. As shown in FIG. 2, the hardware that realizes the power supply analysis model generation apparatus 200 is comprised of an input unit 21, a processor unit 22, a data storage unit 23 and a display unit 24. The input unit 21 receives an input from a user. The processor unit 22 performs data processing including processes involving software which is described later. The data storage unit 23 stores a program to be executed by the processor unit and data needed to generate a power supply analysis model. The display unit 24 displays power supply analysis result and such.

A configuration of the power supply analysis model generation apparatus 200 that the abovementioned processor unit executes is described hereinafter. FIG. 3 is a block diagram showing a configuration example of software for the power supply analysis model generation apparatus according to this embodiment. As shown in FIG. 3, the power supply analysis model generation apparatus 200 includes a data retrieval unit 31, a power supply area extraction unit 32, a mesh partition processor unit 33, a LRGC calculator unit 34, an inductance correction unit 35, and a power supply analysis model storage unit 36.

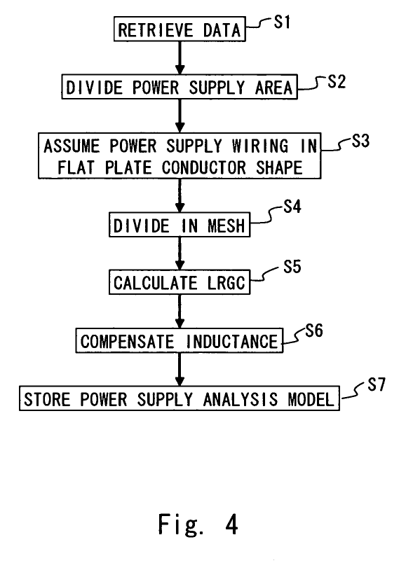

FIG. 4 is a flow chart showing a power supply analysis flow according to this embodiment. The power supply analysis flow of this embodiment is described hereinafter with reference to FIGS. 1 to 4.

In a step S1, the data retrieval unit 31 retrieves a pad arrangement of the semiconductor device 12 on a package substrate and signal information to be input and outputted to each pad from predesigned CAD data and the like. It also retrieves terminal information of bump electrode configuration for the semiconductor apparatus 100 and so on. The retrieved data is stored to the data storage unit 23, which is indicated in FIG. 2. The location where the retrieved data is stored does not necessarily have to be the data storage unit 23 but can be any location that temporarily stores data.

In a step S2, the power supply area unit 32 divides the package substrate 11 of the semiconductor apparatus 100 into a plurality of first areas. In this example, the division is performed according to the data retrieved in the step S1. The package substrate 11 is divided into areas by different power supply system (such as 3.3V and 2.5V), for example. Areas with the same power supply systems but with different number of bumps to be power supply are differentiated to be divided. In an example illustrated in FIG. 1B, the package substrate is divided into four trapezoid shapes. The boundaries between each area are indicated by broken lines in FIG. 1B (See A to D in FIG. 1B). In this example, the part where the semiconductor device 12 is implemented shall not be included in the first areas, considering that no power supply wiring of the package substrate 11 is formed thereon.

In a step S3, the power supply area extraction unit 32 specifies flat plate conductors to be virtual wirings over each of the entire first areas divided in the step S2. At least two flat plate conductors (power supply wiring and ground wiring) are specified to each area. In other words, at least two flat plate conductors are specified to each of the areas A, B, C and D, for an example illustrated in FIG. 1B, which means eight or more flat plate conductors specified in total.

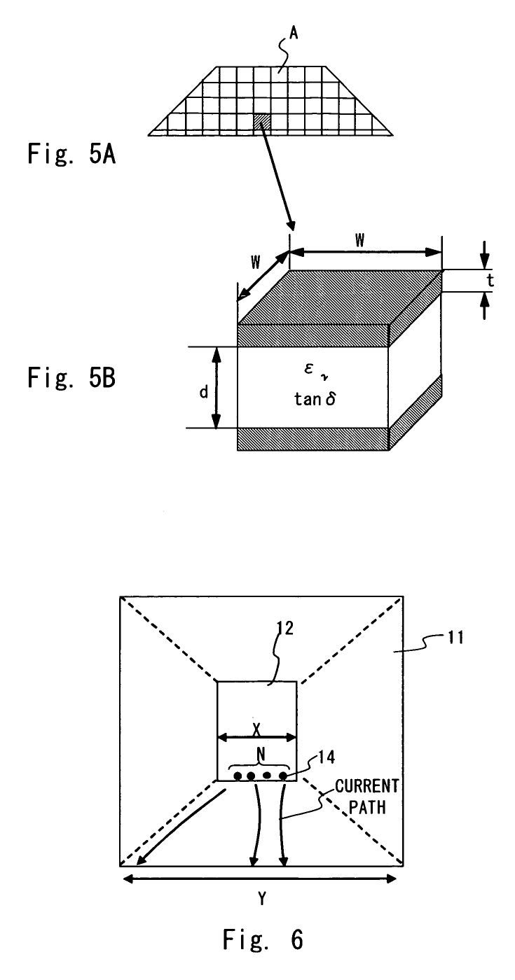

Then, in a step S4, a mesh partition processor unit 33 divides the flat plate conductors specified to each area in the step S3 into a mesh comprised of a plurality of squares. FIG. 5A is a schematic view showing a pattern when dividing the flat plate conductors of an area illustrated in FIG. 1B, for example, into a mesh as described above. By assuming power supply wirings in flat plate conductor shape to each of the first areas and then dividing the flat plate conductors into meshed unit areas as described above, a unit block used for modeling a wiring of a power supply system can be determined.

FIG. 5B represents a wiring model of a unit block for one section of a mesh. The wiring model of this basic unit block may be either stored to the data storage unit as a data or inputted by a user depending on a package substrate to be modeled.

In this example, one side of a square in each unit block for the mesh is indicated by W. As a wiring model, it is modeled as a conductor with a thickness of t on a surface of a block and a dielectric substance with a dielectric constant ε and a loss angle δ being laminated thereunder.

And then in a step S5, the LRCG calculator unit 34 calculates resistance R, inductance L, conductance G and capacitance C for power supply wirings and ground wirings that are specified as flat plate conductors. This calculation is performed assuming that each unit block of the mesh has a characteristic based on the following formula.
Inductance: L=μd
Capacitance: C=ε·W²/d
Resistance: R=2/(σ·t)+{(ω·μ)/(2·σ)}^{0.5}
Conductance: G=ω·C·tan δ
Wherein, μ is an amplitude permeability, ε is a dielectric constant, σ is a conductivity and δ is a loss angle.

The above calculation is carried out according to the number of flat plate conductors specified in the step S3. Using the above formula enables a characteristic calculation regarding power supply system wirings for each area in a package substrate. However at this stage, the number of via holes formed in the power supply system wirings is not taken into account.

In an actual power supply wiring of a package substrate, the power is supplied to the signal lines 15 through the via holes 14 from a print substrate and the like. Since a power supply system wiring model of a package substrate based on the above calculation does not consider an existence of via holes, it could possibly be inaccurate when used in an ex-ante examination of the semiconductor apparatus 100.

For this reason, this embodiment takes the number of via holes into account to model a power supply wiring of a package substrate. Therefore a correction of inductance based on the number of via holes is made as described below.

In a step S6, the inductance correction unit 35 retrieves the number of via holes included in each of the first areas which is divided in the step S2 based on the data retrieved in the step S1, for example. After that in this embodiment, correction of inductance is made depending on the number of via holes under the following assumptions.
via holes for a retrieved number of via holes (let the number be N) are formed in semiconductor device edge of the first area specified in the step S2.
The power supplied by a print substrate and the like to which a semiconductor apparatus is mounted is provided to the via holes through a power supply wiring model in a flat plate conductor shape from a most external side of the semiconductor apparatus.

In other words, this embodiment assumes that the via holes to be in a chip edge of power supply wirings that are assumed to be flat plate conductor shape, in order to correct inductance with a consideration over spreading of current paths. FIG. 6 is an image diagram explaining the semiconductor apparatus performing a via correction as described above.

In a case of an inductance compensation under the assumptions above, a compensated inductance L of a flat plate conductor corresponding with the first area can be expressed by the following formula.

$$\frac{1}{L} = \frac{1}{{L}_{0}} {\sum }_{n = 1}^{N} \frac{1}{\frac{N}{{tan}^{- 1} [ \frac{3 w - \{ 1 + ( 2 n - 1 ) / N \}}{w - 1} ] + {tan}^{- 1} [ \frac{w - \{ 1 - ( 2 n - 1 ) / N \}}{w - 1} ]} + \frac{{L}_{v}}{{L}_{0}}}$$

Wherein, w is a quotient when a package size is divided by a chip size (Y/X in FIG. 6), Lᵥ is an inductance of one via hole and N is a number of via holes.

Based on the correction calculated based on the number of via holes, the inductance correction unit performs an inductance compensation of power supply wirings.

In the step S6, a correction of inductance described above will be carried out against each of the flat plate conductors specified in the step S3. The correction process in the step S6 determines RLGC for each of the flat plate conductors specified in the step S3, thereby modeling the power supply wirings for each of them.

In a step S7, a power supply analysis model storage unit 36 stores data relating to power supply wirings of a package that are produced through S1 to S6 into data storage unit and so forth.

As described so far according to this embodiment, a package substrate is divided into a plurality of first areas classified by different power supply systems and then it is assumed that power supply system wirings in flat plate conductor shape are formed in each area. Furthermore each flat plate conductor is comprised of a plurality of unit meshes and characteristics of a power supply system wiring is estimated according to the characteristics of a unit mesh. Focusing attention on a change of inductance components due to via holes that are peculiar to a package substrate, the correction of inductance is made using data on the numbers of the via holes, and then making it a power supply analysis model of a package substrate. By modeling a package substrate using data as described above, it is possible to produce data that is applicable to a simulation such as SPICE. Furthermore it also enables to estimate in advance without recourse to an electromagnetic field analysis performed after designing a package substrate of a semiconductor apparatus.

Furthermore, the data that models a package generated by a method of this invention is stored as SPICE data, for example, so as to use it for a simulation of a semiconductor device afterward, thereby enabling a power supply analysis with a consideration over both of a package substrate and a semiconductor device.

As this embodiment is described according to the present invention, a power supply analysis of a package substrate to which a semiconductor device and such is mounted facilitates an ex-ante examination for a whole semiconductor apparatus and also enables to remarkably reduce its development time.

Though a preferred embodiment uses the formula for inductance correction based on the number of via holes, the correction may be made based on a correction table including actual values of a past that is prepared in advance, for example.

It is apparent that the present invention is not limited to the above embodiment that may be modified and changed without departing from the scope and spirit of the invention.

What is claimed is:

1. A method of power supply analysis comprising:
dividing a package substrate to which a semiconductor device is mounted into a plurality of first areas;
specifying virtual flat plate conductors to correspond to the plurality of first areas;
calculating a plurality of electrical properties including inductance characteristics of the flat plate conductors; and
correcting the inductance characteristics based on the number of via holes in each of the first areas.

2. The method of power supply analysis according to claim 1, wherein dividing the package substrate into the plurality of first areas is based on pad information of the semiconductor device and terminal information of the package substrate.

3. The method of power supply analysis according to claim 1, wherein calculating electrical properties of the flat plate conductors is performed by dividing the flat plate conductors into a plurality of unit blocks.

4. The method of power supply analysis according to claim 2, wherein calculating electrical properties of the flat plate conductors is performed by dividing the flat plate conductors into a plurality of unit blocks.

5. The method of power supply analysis according to claim 1, wherein a plurality of flat plate conductors corresponding to each of the first area are specified.

6. The method of power supply analysis according to claim 1, wherein the correcting of the inductance characteristics is performed using the following formula:
$$\frac{1}{L} = \frac{1}{{L}_{0}} {\sum }_{n = 1}^{N} \frac{1}{\frac{N}{{tan}^{- 1} [ \frac{3 w - \{ 1 + ( 2 n - 1 ) / N \}}{w - 1} ] + {tan}^{- 1} [ \frac{w - \{ 1 - ( 2 n - 1 ) / N \}}{w - 1} ]} + \frac{{L}_{v}}{{L}_{0}}}$$
wherein L is a corrected inductance characteristic, L₀ is an inductance of the virtual flat plate conductor, N is the number of via holes in the first area, w is a ratio of a size of the package substrate to a size of the semiconductor device that is mounted on the package substrate, and Lᵥ is an inductance of a single via in the first area.

7. A program product to cause a computer to execute the process of power supply analysis for a semiconductor apparatus, the process comprising:
dividing a package substrate to which a semiconductor device is mounted into a plurality of first areas;
specifying virtual flat plate conductors to correspond to the plurality of first areas;
calculating a plurality of electrical properties including inductance characteristics of the flat plate conductors; and
correcting the inductance characteristics based on the number of via holes in each of the first areas.

8. The program product according to claim 7, wherein dividing the package substrate into the plurality of first areas is based on pad information of the semiconductor device and terminal information of the package substrate.

9. The program product according to claim 7, wherein calculating electrical properties of the flat plate conductors is performed by dividing the flat plate conductors into a plurality of unit blocks.

10. The program product according to claim 8, wherein calculating electrical properties of the flat plate conductors is performed by dividing the flat plate conductors into a plurality of unit blocks.

11. The program product according to claim 7, wherein a plurality of flat plate conductors corresponding to each of the first area are specified.

12. The program product according to claim 7, wherein the correcting the inductance characteristics is performed using the following formula:
$$\frac{1}{L} = \frac{1}{{L}_{0}} {\sum }_{n = 1}^{N} \frac{1}{\frac{N}{{tan}^{- 1} [ \frac{3 w - \{ 1 + ( 2 n - 1 ) / N \}}{w - 1} ] + {tan}^{- 1} [ \frac{w - \{ 1 - ( 2 n - 1 ) / N \}}{w - 1} ]} + \frac{{L}_{v}}{{L}_{0}}}$$
wherein L is a corrected inductance characteristic, L₀ is an inductance of the virtual flat plate conductor, N is the number of via holes in the first area, w is a ratio of a size of the package substrate to a size of the semiconductor device that is mounted on the package substrate, and Lᵥ is an inductance of a single via in the first area.
